(19) United States
(12) Patent Application Publication
(10) Pub. No.: US 2009/0037123 A1
(43) Pub. Date: Feb. 5, 2009

(54) Energy Supply System Evaluation Device, Energy Supply System Evaluation Method and Energy Supply System Evaluation Program

(76) Inventors: Masafumi Noujima, Tokyo (JP); Akiyoshi Komura, Hitachi (JP); Yoji Uchiyama, Tsukuba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/184,460

(22) Filed: Aug. 1, 2008

(30) Foreign Application Priority Data
Aug. 1, 2007 (JP) 2007-200627

(51) Int. Cl. G06F 19/00

(52) U.S. Cl. 702/60

(57) ABSTRACT

The present invention provides an energy supply system evaluation device evaluating a lifecycle of energy conversion processes to be implemented in a pre-determined order by an energy supply system, an energy supply system evaluation method and an energy supply system evaluation program. According to the present invention, it can reduce a work load on an evaluator when the evaluator performs many-sided evaluations on energy supply systems by using a variety of analytical methods, and enable the evaluator to gain actualized output of the evaluation results desired thereof.

### FIELD OF THE INVENTION

The present invention relates to an energy supply system evaluation device, an energy supply system evaluation method and an energy supply system evaluation program.

### BACKGROUND OF THE INVENTION

Deterioration of the atmospheric environment due to gases of the greenhouse effect represented by carbon dioxide (CO₂) becomes a serious problem. Particularly, in recent years, is pointed out temperature elevation in a global scale due to an effect of the greenhouse gases, which often turns out to be a serious issue.

Considering the situation, the Kyoto protocol to prevent the global greenhouse progression was effected in February, 2005, and international agreements on numerical objectives for reduction in greenhouse gases, discharge volume business, and cooperative campaign and mechanisms of clean development, were to be completely implemented. Under these circumstances, decrease in discharged volumes of CO₂ is to be an issue for human. This decrease has to be accomplished by means of: utilizing renewable energy, thermally utilizing a currently used fossil fuel in a high efficient electricity generation and decentralized electricity power source, and utilizing a hydrogen energy and a fuel cell.

In order to judge the decentralized electricity source and environmental efficiency of the hydrogen energy in a production lifecycle, it is important to evaluate load in total energy life cycle such as material gathering, distribution, use, disposal recycle process. For example, JP2005-339504 is aimed at estimating environmental load by taking into consideration energy data used in factories in order to calculate environmental load in whole life cycles.

However, it is difficult to introduce the technologies as mentioned above, because a variety of issues are involved, which includes an economical issue in which costs of an electricity generation become higher, a market related issue how to transform the former energy market proficiently, investment issue needed for technology development, an issue on possible timing and reliability of technology, and a political issue.

For example, when a decision maker for energy introduction introduces a distributed energy system, he/she has to evaluate an introducing merit by comparing effects of a distributed electricity power in such a view point as economical, efficiency, environmental points, and an evaluation system of the introduction becomes of importance.

On the contrary, Japanese Laid-Open Patent Application No. 2005-165469 proposes including costs of an environmental load exerted by products through whole of the lifecycle, an evaluation system capable to easily and efficiently evaluated costs, respectively shared by manufactures of the products, users of the products, and society, and a method to evaluate products in a multilateral view point.

Regarding evaluation work of an energy lifecycle, for example, every time evaluation of an apparatus is performed, information of process apparatus and its use is prepared by manual input, and conversion to an evaluation value of environment is performed, and then, an evaluation value is calculated out. In this regard, there is a drawback: an evaluator has to take a number of processing steps, therefore, input errors tended to happen.

On the contrary, Japanese Laid-Open Patent Application No. 2000-16886 is aimed to evaluate and analyze more efficiently by arranging an apparatus in a property data of a component, linking composition of the apparatus and part of the composition to material data and electric parts data, sharing the environment evaluation among evaluators.

There are the following issues (1) and (2) when a lifecycle system of energy process apparatus and a lifecycle system of energy are evaluated. Each of the prior documents has not solved efficiently these issues yet.

(1) In a multilateral evaluation, evaluation axes are different between evaluators, and comparison among evaluations is needed by conducting analysis in plural evaluation axes. In addition, how evaluation results are displayed dependent on evaluators, that is, some evaluators desire to observe only an important evaluation, whereas others desire to observe a total evaluation.

(2) If a variety of analytical methods are adopted, analytical object data, analytical method for analytical object data, and data input into an analytical method, are necessarily increased when an energy process device and a life cycle system of energy are evaluated in a variety of view points. As a result, an energy evaluator needs a hard work load until completing evaluation and analysis. Moreover, when evaluation data are combined, probability for input errors certainly increases because the combination becomes complex associated with increase in the variety of the analytical method.

Thus, an objective of the present invention is to address these issues, and to output evaluation results required for an evaluator with reducing the work load on the evaluator, when an energy supply system is evaluated on a variety of aspects.

### BRIEF DESCRIPTION OF THE INVENTION

For solving the issues mentioned, the present invention provides an energy supply system evaluation device for evaluating a lifecycle of energy conversion processes to be implemented in a pre-determined order by an energy system based on plural evaluation axes, comprising:

a memory section memorizing apparatus data of each apparatus which implements the energy conversion process, the evaluation axes to evaluate the energy supply system, and evaluation method programs to implement evaluation methods on the energy supply system,

an evaluation object editorial section which receives data on the lifecycle as an evaluation object by receiving each of evaluation units consisting of either the energy processing process or an apparatus unit which implements the energy conversion process, and a link relationship between a designated evaluation unit and other evaluation unit,

a data method link section which obtains an input item and an output item for the evaluation method both of which are associated with the evaluation unit by looking up the apparatus data in the memory section by using each of the evaluation units belonging to the input lifecycle, selects the evaluation method program based on the evaluation axis, and links the input item and the output item of the evaluation data to the specified evaluation method program,

an evaluation section for evaluating each evaluation unit by implementing the linked evaluation method program by using the linked input item and output item, and

a display showing an evaluation result produced by the evaluation section in each evaluation unit. Other methods will be mentioned later.

### DETAILED DESCRIPTION OF THE INVENTION

A form of the embodiment of the present invention will be explained hereinafter.

FIG. 1 is a configuration drawing showing a hardware structure of an energy supply system evaluation device 9. The energy supply system evaluating device 9 evaluates an environment load and a product cost of each process or a whole the process to date at the same time, in a lifecycle such as material mining, storage/transportation, conversion/transformation, consumption, disposal, and recycling.

The energy supply system evaluation device 9 evaluates a supply chain of an energy supply system including OA (Office Automation), especially, a personal computer, by evaluation axes such as efficiency, environmental performance, economic performance, marketability, and reliability. The energy supply system evaluation device 9 is composed of an input device 1, a display device 2, a data storage device 3, CPU (Central Processing Unit), and a main memory 7, in which each component is bus connected.

The input device 1 is comprised of an input device such as a key board, a mouse, and an input pen. The display device 2 is comprised of a display device such as a cathode ray tube display and a liquid crystal display. The data storage device 3 is comprised of HDD (Hard Disc Drive) and so on. The CPU 6 executes programs for operating each processing unit read in the main memory 7. The main memory 7 is comprised of RAM (Random Access Memory) and so on. The main memory 7 stores an input unit 21, a display unit 22, a data method linkage unit 23, an evaluation data control unit 24, an evaluation unit 25, evaluation object edition unit 26, and an evaluation unit edition unit.

The data storage device 3 stores an evaluation data 11, an evaluation unit data 12, an evaluation method program 13, an evaluation result data 14, and a unit code Table 15. The evaluation data 11 is comprised of a process machine technique table 11a, an original fuel Table 11b, and a general table 11c. The evaluation result data 14 is comprised of a sheet setting up table 14a, an input setting up Table 14b, an output setting up table 14c, and a unit setting up Table 14d. These data are not necessarily independent.

FIG. 2 is a configuration figure where the energy supply system evaluation device 9 in FIG. 1 is transformed into a distribution system. The data storage device 3 is arranged outside the energy supply system evaluation device 9. When one accesses data in the data storage device 3 from the energy supply system evaluation device 3, one follows such a communication route as the energy system evaluation device 9, a communication device 4a, a communication device 4b, a file server 5, and a data storage device 3. The communication device 4a and the communication device 4b are, for example, routers. The file server 5 deputizes access to the data storage device 3 connected directly, on receiving access requests from other devices.

FIG. 3 is a configuration figure focused on a function of the energy supply system evaluation device 9. FIG. 3 shows a main data flow among the components with arrows.

The input section 21 receives data input from the input device 1, and transmits the input data to each processing unit memorized in the main memory 7. The display 22 displays processing data of each processing unit which are memorized in the main memory 7, on the display device 2.

A data method link section 23 arranges which evaluation axis is used for the evaluation method program 13, or which apparatus classification is corresponding to, by linking the evaluation data 11 to the evaluation method program 13. An evaluation control section 24 receives data needed for evaluation, and records each data input into the evaluation data 11. The evaluation section 25 implements evaluation based on the data arranged in the evaluation result data 14 by the evaluation object edition unit 26, and adds the result to the evaluation result data 14.

The evaluation object editorial section 26 establishes the whole life cycle of energy in the evaluation result data 14, by linking up the evaluation data 11 to evaluation unit data 12 b in each process in a lifecycle portion, and by linking information in an evaluation sheet, arranges whole the lifecycle of energy into the evaluation result data 14. An evaluation unit editorial section 27 makes a user edit the evaluation unit data 12.

The evaluation data 11 controls efficiency, environmental performance, constituting the process. The evaluation unit data 12 is a linked data by the data method link section 23. The evaluation method program 13 is a program to implement evaluation methods, and exists for each evaluation axis and apparatus classification. The evaluation result data 14 is data recording evaluation results by the evaluation section 25, and is displayed or edited to display section 22 in graphic forms. The unit code table 15 is a correspondence table to specify a unit from unit ID memorized in other data.

FIG. 4 is an explanation drawing showing how an evaluation object editorial section 26 is editing the evaluation data 11 (including evaluation axes) and an evaluation unit data (including evaluation units). A vertical direction of FIG. 4 indicates three evaluation axes such as “total efficiency evaluation”, “environment performance evaluation”, and “economical evaluation”. A horizontal direction of FIG. 4 indicates four evaluation units such as “material mining”, “transformation/change”, “transportation”, “use”. Each of the process and evaluation object apparatus has an evaluation unit in each evaluation axis. For example, process A indicates an evaluation unit “use” in each of the evaluation axes.

An energy chain is comprised of a plural evaluation units from “material mining (including mining of original fuel) to “use” Each of these evaluation units is, as a process, evaluated simultaneously based on plural evaluation axes.

FIG. 5 is an outline drawing explaining an evaluation unit of the evaluation unit data 12.

The evaluation unit shown in FIG. 5(A) corresponds to input items equal or more than one and output items equal or more than one. For example, an evaluation unit “hydroelectric power generation” corresponds to 4 input items and 6 output items.

FIG. 5(B) is a drawing explaining a link among evaluation units. The evaluation units are arranged according to a supply chain flow. Herein, in the evaluation unit with a supply chain like “hydroelectric power generation” and an actual evaluation unit “power transmission line”, are in a relationship supplying a product from evaluation unit “hydroelectric power generator”. In order to obtain total evaluation efficiency, evaluation result of efficiency in evaluation unit “hydroelectric power generation” and evaluation result of efficiency in evaluation unit “power transmission line”, need to be multiplied.

For example, in order to obtain total efficiency in a whole supply chain, an efficient evaluation is performed in an evaluation unit “hydroelectric power generation”, and the result is output in the output item “1” of the evaluation unit “hydroelectric power generation”. In this time, from output item “1” of the evaluation unit “hydroelectric power generation”, to the evaluation unit “power transmission line”, a link is formed (expressed in an arrow). In the evaluation unit where evaluation axes are different from each other, it is possible to link input items with output items.

FIG. 6 indicates an example of the evaluation method program 13. The evaluation method program 13 exists in each of apparatus classifications and evaluation axes. An evaluation axis shows a factor which decides superiority or inferiority of an energy supply system. Items used for evaluation axes, for example, are efficiency, environmental performance, economical performance, reliability, R&D property, and marketability, however, it is not limited to the example.

FIG. 6 (A) expresses the evaluation method program 13 in a text file format, and FIG. 6 (B) expresses the evaluation method program 13 in FIG. 6 (A) as a CSV (Comma Separated Values) file format (table format). In each of the evaluation method program 13, a file name is specified to distinguish the evaluation method program from other evaluation method programs 13, and is preserved.

Based on FIG. 6 (B), the evaluation method program 13 will be explained specifically. An order number field (1˜6 in a front column of each row), defines a line number showing an order of program execution.

An execution order field ($SUBIN showing a defined order of the input item in the first line, $SUBOUT showing a defined order of the output item in the second line, $EXIT showing program termination order in the sixth line), shows an execution instruction.

A variable data field (the forth and more ordered column in each line) records numbers and variables used for calculation.

An execution order field (the third column in 3˜5 line) defines a single operation unit and an order function like +, −, *, ./.

Result field (the second column in 3˜5 line) defines a variable name obtained as a result of an operation method defined in an execution order field and variable data field.

TABLE 1
11a Process apparatus technique table

| | chain | apparatus | apparatus | technique | basic fuel | product |
|---|---|---|---|---|---|---|
| id_technique | classification | classification | name | period | name | name |
| 1 | fuel mining | coal mining | mining e | 2001 | import | import |
| | | | apparatus | | general coal | general coal |
| 2 | fuel mining | petroleum | mining | 2001 | crude | crude |
| | | mining | apparatus | | petroleum | petroleum |
| | | | (LHV) | | | |
| 3 | fuel mining | petroleum | mining | 2003 | crude | crude |
| | | mining | apparatus | | petroleum | petroleum |
| | | | (HHV) | | | |
| 4 | fuel mining | petroleum | mining | 2003 | crude | crude |
| | | mining | apparatus | | petroleum | petroleum |
| | | | (C Co.) | | | |
| 5 | fuel mining | coal mining | mining e | 2004 | import | import |
| | | | apparatus | | general coal | general coal |
| | | | (general | | | |
| | | | A) | | | |
| 6 | fuel mining | coal mining | mining | 2006 | import | import |
| | | | apparatus | | general coal | general coal |
| | | | (general | | | |
| | | | B) | | | |
| 7 | fuel mining | petroleum | mining | 2005 | crude | crude |
| | | mining | apparatus | | petroleum | petroleum |
| | | | (A Co.) | | | |
| 8 | fuel mining | petroleum | mining | 2004 | crude | crude |
| | | mining | apparatus | | petroleum | petroleum |
| | | | (B Co.) | | | |
| 9 | fuel mining | petroleum | mining | 2003 | crude | crude |
| | | mining | apparatus | | petroleum | petroleum |
| | | | (D Co.) | | | |

TABLE 2
11a Process apparatus technique table (cont.)

| specific volume | | | instrument efficiency | | |
|---|---|---|---|---|---|
| value | unit | comment | value | unit | comment |
| 2000 | 21 | | 93.6 | 84 | |
| 24 | 12 | calc. on data | 98 | 84 | calc. on data of a variety of |
| | | of a variety | | | documents |
| | | of documents | | | |
| 2400 | 21 | | 99 | 84 | calc. on data of a variety of |
| | | | | | documents |
| 2400 | 21 | | 98 | 84 | calc. on data of a variety of |
| | | | | | documents |
| 200 | 21 | | 97 | 84 | calc. on data of a variety of |
| | | | | | documents |
| 22 | 12 | | 97 | 84 | calc. on data of a variety of |
| | | | | | documents |
| 20 | 12 | | 97 | 84 | calc. on data of a variety of |
| | | | | | documents |
| 1222 | 21 | | 96.2 | 84 | calc. on data of a variety of |
| | | | | | documents |
| 200 | 21 | | 97.6 | 84 | calc. on data of a variety of |
| | | | | | documents |

TABLE 3
11a Process apparatus technique table (cont.)

| investment cost | | | de-sulfur device cost | | |
|---|---|---|---|---|---|
| value | unit | comment | value | unit | comment |
| 100 | 20 | | 100 | 20 | |
| 200 | 20 | calc. on data of a variety | 200 | 20 | calc. on data of a variety of |
| | | of documents | | | documents |
| 300 | 20 | calc. on data of a variety | 300 | 20 | calc. on data of a variety of |
| | | of documents | | | documents |
| 500 | 20 | calc. on data of a variety | 500 | 20 | calc. on data of a variety of |
| | | of documents | | | documents |
| 100 | 20 | calc. on data of a variety | 100 | 20 | calc. on data of a variety of |
| | | of documents | | | documents |
| 200 | 20 | calc. on data of a variety | 200 | 20 | calc. on data of a variety of |
| | | of documents | | | documents |
| 300 | 20 | calc. on data of a variety | 300 | 20 | calc. on data of a variety of |
| | | of documents | | | documents |
| 500 | 20 | calc. on data of a variety | 500 | 20 | calc. on data of a variety of |
| | | of documents | | | documents |
| 900 | 20 | calc. on data of a variety | 900 | 20 | calc. on data of a variety of |
| | | of documents | | | documents |

TABLE 4
11a Process apparatus technique table (cont.)
R&D cost

| value | unit | comment |
|---|---|---|
| 100 | 20 | |
| 200 | 20 | calc. on data of a variety of documents |
| 300 | 20 | calc. on data of a variety of documents |
| 500 | 20 | calc. on data of a variety of documents |
| 100 | 20 | calc. on data of a variety of documents |
| 200 | 20 | calc. on data of a variety of documents |
| 300 | 20 | calc. on data of a variety of documents |
| 500 | 20 | calc. on data of a variety of documents |
| 900 | 20 | calc. on data of a variety of documents |

The process apparatus technique table 11a shown in Table 1˜Table 4, houses each column in Table 1 (id_technique, chain classification, apparatus classification, apparatus name, technique period, basic fuel name, crude production name), and each column in Table 2 (designated volume, apparatus efficiency), and each column in Table 3 (cost of apparatus, cost of de-sulfur device), and each column in Table 4 (R&D cost), all of which associated with one another. Each column in Table 2˜4 consists of a value of parameter which the column shows, a unit of the value, and comments concerning to the value. If a unit is a numerical value, the numerical value stands for a unit ID, and by referring the unit code table 15, the unit is specified.

The process apparatus technique table 11a, besides the data exemplified in Table 1 Table 4, includes technique specific data concerning to an apparatus specification like an apparatus efficiency of processing, and performance data showing a performance of a processing apparatus like a rated volume, efficiency, economical data such as investment costs, running and maintenance costs, and labor costs, environmental data on environmental performance data on environmental action of investment, R&D (Research and Development) money and period consumed in development of process apparatus, reliability data on trouble ratio of apparatus, marketability data on a market scale of energy such as energy demand and energy supply.

An “id_technique” column stores ID for the process apparatus. The ID can contain, for example, a model version of process apparatus. A column of “chain classification” stores a supply chain to which process apparatus belongs, for example, fuel mining, pre-treatment/change, overseas transport, usage, recovery, recycling.

The classification method is not limited herein, for example, domestic transportation can be classified as divided in domestic grand transportation and domestic shipping, and transportation can be used by combining domestic transportation and overseas transportation. However, once the classification definition is defined, after that, it is better to keep the classification method unchanged.

A column of “apparatus classification” stores a process name and a general apparatus name. For example, a name stored is such as a press apparatus, an automobile, an electricity power generation.

A column of “apparatus name” stores an individual identification name of apparatus belonging to process. Herein, an individual identification name indicates, in case of a power generation as an apparatus classification, the apparatus classification with a modifier such as an electricity power generation maid by A company, a model name like A-105, and a product name like an economical power generation. A “technique period” is described as a year when a selling apparatus name stood. In case that 0 is described, this means no assumption is for a year.

Columns of a “basic fuel name” and a “product name”, store a basic fuel name processed and preserved in each process, and a product name of a product which is forwarded to the next process. For example, in case of a crude petroleum tanker, crude petroleum is described because a basic fuel oil delivered is crude petroleum, and crude petroleum is also input in the column of a product name.

TABLE 5
11b Basic fuel table

| | | | density | | |
|---|---|---|---|---|---|
| id_fuel | basic fuel name | year | value | unit | comment |
| 1 | cokes furnace gas | 0 | 0 | 96 | |
| 2 | imported raw material coal | 0 | 0 | −1 | |
| 3 | imported general coal | 0 | 0 | −1 | |
| 4 | cokes | 0 | 0 | −1 | |
| 5 | blast furnace gas | 0 | 1.37 | 96 | |
| 6 | revolving furnace gas | 0 | 1.34 | 96 | |
| 7 | crude petroleum | 0 | 0.854 | 92 | |
| 8 | naphtha | 0 | 0.723 | 92 | |

TABLE 6
11b Basic fuel table (cont.)

| CO2 excretion origin | | | FOB cost | | |
|---|---|---|---|---|---|
| value | unit | comment | value | unit | comment |
| 0.0454 | 81 | LHV | 0 | 74 | |
| 0.0904 | 81 | | 11021 | 74 | yen/t: |
| | | | | | energy economic statics handbook2007 |
| 0.0904 | 81 | | 7230 | 74 | yen/t: |
| | | | | | energy economic statics handbook2007 |
| 10108 | 81 | | 0 | 74 | |
| 0.261 | 81 | LHV | 0 | 65 | |
| 0.186 | 81 | LHV | 0 | 74 | |
| 0.0727 | 81 | | 0.465 | 74 | |
| 0.0688 | 81 | LHV | 40336 | 74 | yen/t: |
| | | | | | energy economic statics handbook2007 |

A basic fuel Table 11b shown in Table 5˜Table 6, stores data in each column in Table 5 (id_fuel, basic fuel name, year, density) to each column in Table 6 (CO₂ discharge field, FOB (Free On Board) cost, all of which are associated with each other.

Basic fuel Table 11b stores besides the data exemplified in Table 5˜Table 6:

economical data such as crude petroleum as a material of energy and fuel, natural gas, coal and the fuel itself, for example, a density of gasoline and electricity, fuel physical data like a calorific value, environmental performance data such as sulfur containing quantity, CO₂ discharge basic unit, or, economical data like overseas and domestic costs of a basic fuel.

A column of “id_fuel” in FIG. 5 stores ID for a basic fuel. The ID can contain quality and the original home of the basic fuel.

A column of “basic fuel name” stores a name of the original fuel.

A column of “year” stores a year when an basic fuel was mined in general. However, besides this, the column has capability to store a year when physical properties of the basic fuel were evaluated, and a year when a fuel was dealt with. A year when an apparatus was on sale is mentioned. If 0 is referred to, it indicates that a year is not assumed in particular.

A column of each parameter in Table 5 and Table 6 (density, CO2 discharged basic unit, FOB cost) is relevant to an basic fuel specified by “basic fuel name”.

TABLE 7
11c General table

| id_Common | item name | year | value | item_unit | comment |
|---|---|---|---|---|---|
| 1 | interest rate | 2004 | 1.65 | 83 | general |

The general Table 11c in FIG. 7 stores the following items: id_common, item name, year, value, item_unit, and comment, all of which are associated with one another. The general Table 11c stores calculation data such as the rate of interest and rising rate of price which do not belong to the process apparatus technique Table 11a or the basic fuel Table 11b.

A column of “id_common” stores ID of data items.

A column of “item name” stores data names.

A column of “year” stores years in general, a year when a document is adopted, and a year when data is searched for. However, it is not limited herein.

A column of “value” stores numerous values corresponding to the items and years.

A column of “item_unit” stores unit code or unit ID.

A column of “comment” stores comments.

TABLE 8
12a Basic table

| | | evaluation | chain | apparatus | input | output |
|---|---|---|---|---|---|---|
| id_sub | evaluation method | axis | classification | classification | no. | no. |
| 1 | SUB_manufacturing | cost | use | CHG-> on | 10 | 7 |
| | apparatus_COST | | | vehicle CHG | | |
| | | | | filling up | | |
| 2 | SUB_manufacturing | cost | fuel mining | NG gathering | 10 | 7 |
| | apparatus_COST | | | | | |
| 3 | SUB_apparatus | environment | conversion/ | DME transquality | 10 | 5 |
| | CO₂ | | transformation | | | |
| 4 | SUB_apparatus | environment | use | gas supply | 10 | 5 |
| | CO₂ | | | | | |
| 5 | SUB_CGS | efficiency | use | CGS | 6 | 8 |
| 6 | SUB_apparatus | environment | use | CGS | 10 | 5 |
| | CO₂ | | | | | |
| 7 | SUB_manufacturing | cost | use | CGS | 10 | 7 |
| | apparatus_COST | | | | | |
| 8 | SUB_power | cost | inland | electricity | 3 | 3 |
| | transmission cost | | transport | tranmission | | |
| | | | | distribution | | |
| 9 | SUB_storage | efficiency | storage | LNG storage | 7 | 9 |
| 10 | SUB_apparatus | environment | overseas | kerosenecoastal | 10 | 5 |
| | CO₂ | | transport | tanker transport | | |

TABLE 9
12a Basic table (cont.)

| input item 1 | unit 1 | input unit 2 | unit 2 | | input item 2 | unit n |
|---|---|---|---|---|---|---|
| basic fuel cost | 74 | apparatus volume | 66 | — | efficiency | 84 |
| basic fuel cost | 74 | apparatus volume | 66 | — | efficiency | 84 |
| cumulative CO₂ | 97 | cumulative apparatus | 97 | — | use CO₂ | 81 |
| dischargevolume input | | use CO₂ volume | | | discharge | |
| | | | | | coefficient | |
| cumulative CO₂ | 97 | cumulative apparatus | 97 | — | use CO₂ | 81 |
| discharge volume input | | use CO₂ volume | | | discharge | |
| | | | | | coefficient | |
| material energy volume | 56 | cumulative utility | 56 | — | | 0 |
| | | volume input | | | | |
| cumulative CO₂ | 97 | cumulative apparatus | 97 | — | use CO₂ | 81 |
| discharge volume input | | use CO₂ volume | | | discharge | |
| | | | | | coefficient | |
| basic fuel cost | 74 | investiment volume | 66 | — | eficiency | 84 |
| basic fuel cost input | 74 | power transmition unit | 85 | — | | 0 |
| | | price | | | | |
| material energy volume | 56 | cumulative utility | 56 | — | | 0 |
| | | volume input | | | | |
| cumulative CO₂ | 97 | cumulative investiment | 97 | — | use CO₂ | 81 |
| discharge volume input | | use CO₂ volume | | | discharge | |
| | | | | | coefficient | |

TABLE 10
12a Basic table (cont.)

| output item 1 | output unit 1 | | output item n | output unit n |
|---|---|---|---|---|
| product cost | 74 | — | | 0 |
| product cost | 74 | — | | 0 |
| cumulative CO₂ | 97 | — | | 0 |
| discharge volume output | | | | |
| cumulative CO₂ | 97 | — | | 0 |
| discharge volume output | | | | |
| final output | 56 | — | | 0 |
| cumulative CO₂ | 97 | — | | 0 |
| discharge volume output | | | | |
| product cost | 74 | — | | 0 |
| product cost | 74 | — | | 0 |
| final output | 56 | — | | 0 |
| cumulative CO₂ | 97 | — | | 0 |
| discharge volume output | | | | |

The basic Table 12a shown in Table 8˜Table 12a, stores the following columns, all of which are associated with one another,

each column in table 8 (id_sub, evaluation method, evaluation axes, chain classification, apparatus classification, input number, output number), each column in Table 9 (input item “1”˜“n” and the unit and each column in Table 10 (output items ‘1’˜n and the unit “1”˜“n”).

A column of “id_sub” in FIG. 8 stores IDs of the evaluation method program 13. There are as many ID numbers as the combination of the chain classification, the apparatus classification and the evaluation axis.

A column of “evaluation method” stores file names of the evaluation method program 13.

A column of “evaluation axis” stores evaluation contents of the evaluation method program 13, for example, efficiency, environmental performance, economical performance are mentioned.

Columns of “chain classification” and “apparatus classification” store the chain classification name and apparatus classification name belonging to the object evaluated by the evaluation method program 13.

Columns of “input number” and “output number” respectively store the number of the input item and the output item of the evaluation method program 13. Herein, numerical data is stored in the column.

A column “input item” in Table 9 stores input items and the unit in the evaluation method program 13.

A column “output item” in Table 10 stores output items and the unit in the evaluation method program 13.

TABLE 11
12b Link table

| | | data table | | | numerical value |
|---|---|---|---|---|---|
| id_sub | input_ID | name | item name | item field name | field name |
| 0 | 3 | technique | Apparatus | efficiency (entire load) | efficiency |
| | | | type | | |
| 0 | 4 | technique | Apparatus | efficiency (entire load) | efficiency |
| | | | type | | |
| 1 | 10 | technique | Apparatus | efficiency (entire load) | efficiency |
| | | | type | | |
| 4 | 6 | fuel | fuel name | gas | CO₂ |

A link Table 12b shown in Table 11 stores id_sub, input_ID, data table name, item name, item field name and numerical value field name, all of which are associated with one another. The evaluation data 11 and input item of the evaluation method program 13 are made associated each other in the link Table 12b.

A column of “id_sub” stores ID for the evaluation method program 13. There are as many IDs as the number of the combination of the chain classification, the apparatus classification and the evaluation axis.

A column of “input_ID” stores input numbers in the evaluation method program 13 specified in id_sub.

A column of “data table name” stores names of tables in which reference data are stored.

A column of “item name” stores key item names such as an equipment type and a fuel name.

Columns of “item field name” and “numerical value field name” specify a data item name and numerical value field name. However, the specific numerical value is not determined because the apparatus name is not specified so far at the timing.

As explained above, evaluation unit data 12 (basic Table 12a and link Table 12b can simplify input work at the evaluation timing, by storing data to specify the evaluation method program 13 and the evaluation data 11, and linking the evaluation method program 13 to the evaluation data 11.

TABLE 12
14a Sheet setting up table

| | | | |
|---|---|---|---|
| | | calculation | evaluation |
| id_sheet | sheet name | mode | year |

| | |
|---|---|
| 51 | crude perroleum~gas |
| | purification~vehicle |
| 52 | crude petroleum~gas |
| | quality improvement~HHG |
| 53 | crude petroleum~gas |
| | quality improvement~LH |

A sheet setting up Table 14a shown in Table 12 stores id_sheet, sheet names, calculation modes, and evaluation years, all of which are associated with one another. The sheet setting up Table 14a stores data to complete the evaluation sheet of the evaluation object editorial section 26.

A column of “id_sheet” stores ID for the evaluation sheet.

A column of “sheet name” stores names of evaluation sheets which an evaluator set up optionally.

A column of “calculation mode” stores calculation modes such as single calculation, plural numbered calculation, random calculation, random numbered calculation, and optimal calculation. The items should be stored after completion of the calculation.

A column of “evaluation year” stores year/month/day in which the main data used for the calculation are input.

TABLE 13
14b Input setting up table

| | evaluation | evaluation | | | | |
|---|---|---|---|---|---|---|
| id_sheet | axis | unit id | input_no | input item name | unit type | unit |
| 1 | 0 | 0 | 1 | material energy volume | energy | MJ |
| 1 | 0 | 1 | 1 | material energy volume | energy | MJ |
| 1 | 0 | 1 | 2 | cumulative utility input | energy | MJ |
| 1 | 0 | 1 | 3 | total efficiency | ratio | % |
| 1 | 0 | 1 | 4 | apparatus efficiency | ratio | % |

TABLE 14
14b Input setting up table (cont.)

| | input | | | input DB |
|---|---|---|---|---|
| link type | data | link table | item name | data |
| 0 | 100 | | | |
| 2 | | | | |
| 0 | 0 | | | |
| 0 | 100 | | | |
| 1 | | technique | efficiency | 96.2 |
| | | | (whole load) | |

TABLE 15
14b Input setting up table (cont.)

| link end | link end | link end output | evaluation |
|---|---|---|---|
| evaluation axis | evaluation unit ID | number | year |
| 0 | 0 | 1 | |

An input setting up Table 14b shown in Table 13˜Table 15, stores each column in Table 13 (id_sheet, evaluation axis, evaluation unit id, input_no, input item name, unit class distinction, unit), each column in Table 14 (link type, input data, link table, item name, input DB data), and each column in Table 15 (link end evaluation axis, link end evaluation unit ID, link end output number, evaluation year), all of which are associated with one another. The input setting up Table 14b sets up data concerning input items in the unit setting up Table 14d.

A column of “id_sheet” in Table 13, stores ID for an evaluation sheet to which an evaluation unit belongs.

A column of “evaluation axis” stores evaluation axes to which an evaluation unit belongs. Herein, data capacity can be reduced if the evaluation axis sets up the evaluation axis ID (efficiency: 0, environmental performance: 1, economical efficiency: 2, - - - ).

A column of “evaluation unit id” becomes ID to discriminate each evaluation on the evaluation sheet. ID can be added according to the order which made an evaluation unit, or coordinates which constitute an evaluation unit. However, there are other methods to add ID.

A column of “input_no” stores the correspondent input item numbers.

An input_no, an input item name, unit are set up based on the evaluation unit data 12. Columns of “input item name”, unit type” and “unit” store respectively the item name, the unit classification, and the unit correspondent to each input item.

A column of “link type” in Table 14 stores data types input to data items. For example, when an evaluator directly inputs data at a time of evaluation, 0 is stored; and when data is input from the process apparatus technique Table 11a, basic fuel Table 11b, and general Table 11c, 1 is stored; and when calculation results are input from other evaluation units, 2 is input.

A column of “input data” stores the numerical value, when 0 is stored in a link type, that is, when data was directly input.

Columns of “link table”, “item name”, and “input DB data” store the table name, the item name and the data when 1 was stored in a link type, that is, when the data from the link Table 12b was extracted.

Columns of “link end evaluation axis”, “link end evaluation unit ID”, “link end output number” in FIG. 15 store the evaluation axes in the link end evaluation axis to which link end evaluation unit belongs, when 2 is selected in a link type, namely, calculation results are input from other evaluation units. An evaluation unit ID is stored in the link end evaluation axis, and output_no is stored in the link end output number. Output_no is stored in the output setting up Table 14c which will be mentioned later.

TABLE 16
14c Output setting up table

| | evaluation | evaluation | | output item | | | | |
|---|---|---|---|---|---|---|---|---|
| id_sheet | axis | unit id | output_no | name | unit type | unit | result | year |
| 273 | 1 | 169 | 2 | investiment | weight | kg | | 0 |
| | | | | use CO₂ | | | | |
| | | | | volume | | | | |
| | | | | output | | | | |
| 273 | 0 | 161 | 3 | energy loss | energy | MJ | | 0 |
| | | | | volume | | | | |
| 273 | 1 | 166 | 3 | CO₂ | weight | kg | | 0 |
| | | | | discharge | | | | |
| | | | | volume | | | | |
| 273 | 1 | 166 | 4 | CO₂ | discharge | kg/MJ | | 0 |
| | | | | discharge | coefficient | | | |
| | | | | origin unit | | | | |

An output setting up Table 14c shown in Table 16, stores id_sheet, evaluation axis, evaluation unit id, output_no, output item name, unit type, result, and year, all of which are associated with one another. The evaluation sheet is recorded by storing these data in the evaluation result data 14.

A column of the “Id_sheet” stores ID of the evaluation sheet to which an evaluation unit belongs.

A column of the “evaluation axis” stores the evaluation axis to which an evaluation unit belongs. Herein, the data volume can be reduced by setting up the evaluation axis ID (efficiency: 0, environmental performance: 1, economical performance: 2, - - - ) in the evaluation axis.

A column of “evaluation unit id” becomes ID to distinguish each evaluation of the evaluation sheet. With respect to the assignment method, the followings are exemplified: order for preparing the evaluation unit or coordinates for preparing the evaluation unit.

A column of “output_no” stores the correspondent output item number.

Columns of “output item name”, “unit type”, and “unit” store an item name, unit classification, and unit correspondent to the output item, respectively.

The “output_no”, output item name and unit are set up by the evaluation unit data 12.

A column of “result” stores evaluation result values after calculating the result at the evaluation implement timing.

A column of “year” is an evaluation year item, and can store the result in every evaluation year by using the column as a key.

TABLE 17
14d Unit setting up table

| | evaluation | evaluation | coordinates | coordinates | evaluation unit | evaluation |
|---|---|---|---|---|---|---|
| id_sheet | axis | unit id | (x) | (y) | name | method |
| 1 | 0 | 0 | 358 | 365 | wind power | SUB_fuel |
| 1 | 0 | 1 | 358 | 665 | compressor 1 | SUB_conversion |
| | | | | | | transformation |
| 1 | 1 | 2 | 358 | 665 | compressor 1_environment | SUB_instrument |
| | | | | | | CO₂ |
| 1 | 0 | 3 | 358 | 965 | tank rolly 1 | SUB_inland |
| | | | | | | transport |
| 1 | 1 | 4 | 358 | 965 | tank rolly 1_environment | SUB_instrument |
| | | | | | | CO₂ |

TABLE 18
14d Unit setting up table (cont.)

| | Instrument | input | output | basic fuel | |
|---|---|---|---|---|---|
| chain classification | classification | number | number | name | product name |
| fuel mining | material | 1 | 1 | electricity | natural energy |
| conversion/transformation | HG | 7 | 9 | hidrogen | compressed |
| | compression | | | | hydrogen |
| conversion/transformation | HG | 10 | 5 | hidrogen | compressed |
| | compression | | | | hydrogen |
| inland transport | CHG lorry | 7 | 9 | compressed | compressed |
| | transport | | | hydrogen | hydrogen |
| inland transport | CHG lorry | 10 | 5 | compressed | compressed |
| | transport | | | hydrogen | hydrogen |

A unit setting up Table 14d shown in Table 17˜Table 18, stores each of the columns in Table 17 (id_sheet, evaluation axis, evaluation unit id, coordinate (x), coordinate (y) evaluation unit name, evaluation method), and each of the columns in Table 18 (chain classification, apparatus classification, output number, basic fuel name, product name), all of which are associated with one another.

Columns of “id_sheet”, “evaluation axis”, and “evaluation unit id” are the same explained in the evaluation setting up Table 14c.

Columns of “coordinates (x)” and “coordinates (y)” store horizontal direction (x) coordinates and vertical direction (y) coordinates, respectively.

A column of “evaluation unit name” stores an equipment name shown by the evaluation unit.

Columns of “evaluation method”, “chain classification”, and “apparatus classification” store the file name, the chain classification, and the apparatus classification in the evaluation method program 13 belonging to the evaluation unit.

Columns of “input number” and “output number” store the input numbers and output numbers of the file name in the evaluation method program 13 belonging to the evaluation unit, respectively.

TABLE 19
15 Unit code table

| unit ID | unit |
|---|---|
| 1 | kg |
| 2 | MJ |
| 3 | kg |
| 4 | kg/MJ |

A unit code Table 15 shown in Table 19 controls the unit ID and ID which are associated with each other. If a numerical number is input in the “unit” column in any of other tables, the unit ID is retrieved by using the number as a search key, and the unit of the table is determined based on the result.

FIG. 7 is a display drawing showing a data editorial picture by an evaluation data control section 24. The evaluation data control section 24 accesses the evaluation data 11 (the process apparatus technique Table 11a shown in Table 1˜Table 4), the basic fuel table 11b shown in Table 5˜Table 6, and the data general Table 11c shown in table 7; and inputs and reads the data. The evaluation data 11 classifies the data by letting the ID (id_technique) in the top column of each table be a main key. As an example of the data editorial display, the editorial display of the process apparatus technique Table 11a is shown.

A user inputs the data by designating the objective cell with the input device 1 when performing the data input. The user can narrow down the information by performing the search function when each data item name and a number are specified.

When preparing a brand new data, the user pushes a button having a function of causing an event of a brand new preparation, then, inputs the data on the new input items. Herein, regarding the data item input format, a variety of methods such as a table type come to be possible.

With respect to reading, addition, and update of data items, the user selects data belonging to the object apparatus name among already stored data, that is, data shown in the display in FIG. 7, and then, pushes the button having a function to display the detailed data, and reads, adds, updates input items.

FIG. 8 shows an example of a picture display of an evaluation unit property carried out by the evaluation unit editorial section 27. An evaluation property picture contains an evaluation object setting up column 271, an evaluation axis tab column 272, an evaluation method program name setting up column 273, an input data setting up column 274, and an output data setting up column 275. The input data setting up column 274 contains an item name column 274a, a link end/number column, and an unit column 274c. The output data setting up column 275 contains an item name column 275a and a unit column 275b.

The evaluation object setting up column 271 sets up a chain classification and an apparatus classification of the evaluation object. Herein, as an internal treatment, an evaluation unit data 12 is searched by using the setting up chain classification and apparatus classification as a key. For example, an “apparatus name” column displays the data stored in the apparatus name item of the process apparatus technique table 11a.

An evaluation axis tab column 272 displays an evaluation method program name setting up column 273, an input data setting up column 274, and an output data setting up column 275 of the evaluation method program 13, as a tab format in each of the evaluation axes. By this process, an evaluation unit of each evaluation axis and the same apparatus can be set up without performing any additional work of the evaluation unit. Although each data can be read out from book data and other data, the data input by a method except for read-out is possible. These series of processes are set up for the evaluation axis to be desired, such as efficiency, environmental performance and economical performance.

If id_sub on hit is found out as a search result of the evaluation unit data 12 conducted by the evaluation object setting up column 271, the evaluation method program name setting up column 273 menu-displays the evaluation method program name associated with the found out id_sub. An evaluator selects an evaluation method program name anticipated among evaluation methods programs menu-displayed.

The input data setting up column 274 displays the data of input items of the evaluation method program 13 selected by an evaluator in the evaluation method program name setting up column 273, and enables the editing. Namely, input entrances corresponding to the input number of the evaluation method programs 13 selected, are arranged from the upper site in the order of input items.

An item name column 274a displays the unit data on input items (input item “1”˜“n”) corresponding to id_sub of the evaluation method program 13 selected, and enables the editing.

If the link data is registered corresponding to id_sub of the evaluation method program 13 selected from the link table 12b, a link end/number column 274b outputs the data.

A unit column 274c outputs the unit of input items: “1”˜“n”.

The output data setting up column 275 displays the data of the output items (output item “1”˜“n”) of the evaluation method program 13 selected by an evaluator in the evaluation method program name setting up column 273, and enables the editing. Namely, the number of output entrances corresponding to the output number of the evaluation method program 13 selected, are arranged from an upper site in order of the output items.

An item name column 275a displays unit data of the output items corresponding to id_sub of the evaluation method program 13 selected, and enables the editing.

A unit column 275b outputs the unit of output items: “1”˜“n”.

FIG. 9 shows an example of a setting up display of the data method link section 23. The setting up display has an evaluation method program selection column 231, an evaluation method program setting up column 232, an input data setting up column 233 and an output data setting up column 234. The evaluation method program setting up column 232 has a subroutine name column 232a, a calculation name column 232b, a chain name column 232c, an apparatus type column 232d, and an item number setting up column 232e.

The evaluation method program selection column 231 gives an instruction for an evaluator to select the evaluation method program 13, and reads out the files. When this procedure is performed, the evaluation method program selection column 231 reads a file name and all of the items in $SUBIN and $SUBOUT in the files.

The evaluation method program setting up column 232 outputs the data on the evaluation method program 13 selected by the evaluation method program selection column 231.

The sub-routine name column 232a outputs file names of the evaluation method program 13 selected.

The calculation name column 232b is a column for setting up evaluation axes. With respect to this setting up, it is desirable to select the evaluation axes already decided, for example, if the evaluation method program 13 belongs to the efficiency calculation, efficiency must be selected.

A chain name column 232c searches chain classification names stored in the chain classification column of the process apparatus technique Table 11a, and reads out, then, displays the whole lists read out. The chain name column 232c selects optional items among the chain classification names, and displays the whole lists selected.

An apparatus type column 232d searches the apparatus classification names stored in the apparatus classification column in the process machine technique table 11a, and reads out, displays the whole lists read out. When apparatus classification is set up, if chain classification is already set up, more focused data can be displayed for a person working on choice, by searching only the apparatus classification belonging to the selected chain classification, next, reading out, finally, displaying the whole lists read out.

An item number setting up column 232e outputs the number of input items shown in $SUBIN of the evaluation method program 13 selected, and the number of output items shown as $SUBOUT.

An input data setting up column 233 outputs each input item shown as $SUBIN of the evaluation method program 13 selected, in order of the item description.

An output data setting up column 234 outputs each of the input items shown as $SUBOUT of the selected evaluation method program 13.

Next, when there are data subjected to be linked with each of the input items displayed in an input data setting up column 233, a link setting up on the data is performed in the following steps.

For example, in case that “apparatus efficiency” data is desired to be linked with the input items of the item number 3, menu-display of the link item names is performed by using a chain classification and an apparatus classification as a key step. Herein, the items output in the menu-display become the data item names in each of the tables mentioned previously.

For example, if a chain classification is a fuel mining, and an apparatus efficiency is displayed in the item name 3, id_technique where a chain classification of the process apparatus technique is a fuel mining and an instrument classification is a coal mining, is searched, and then, all of the item names of the searched ID are displayed, when “apparatus efficiency” is selected in a link item name, Id fuel corresponding to a fuel name stored in the basic fuel name data column and the product name data column in id_technique is searched, and then, all of the item names are displayed, in the same way. In addition, item names are displayed by extraction all of the data items from the general Table 11c.

It is desirable to select the data item list in a pull-down indication, however, it is not restricted herein. Particularly, if no numeral value is stored in a column of data item name and a column where data numeral value is stored in a pull-down menu, it is possible not to output the data item name. At the same time in selecting the data item name, the unit code table is shown in a unit section, by using such keys as a chain classification, an apparatus classification item name, and a data item name.

An apparatus efficiency is shown in the item name 3, in which a chain classification means a fuel mining and an apparatus classification means a coal mining. Herein, if “apparatus efficiency” is selected in a link item name, id_technique where a chain classification is a fuel mining and an apparatus classification is a coal mining in the process apparatus technique table 11a, is searched, and then, the unit of efficiency data among them is extracted, and is shown in a unit column. A display method in a unit column is not restricted herein, thus, if there is a unit code Table 15, it is possible to select one from the unit code Table 15, and input the unit directly.

Next, an output item and a unit are set up in the output data setting up column 234. The display method in the unit column is not limited herein. If there is a unit code Table 15, it is possible to select one from the unit code table 15 and input the unit directly. Herein, relationship between input and output data at evaluation timing is established in setting up evaluation axes, evaluation object apparatus, and evaluation method data. The relationship established in the data method link section 23, is stored in the evaluation unit data 12.

FIG. 10 is a picture drawing indicating an example of the display of an evaluation object editorial section 26. The evaluation object editorial section 26 is provided with a sheet column 261, an evaluation axis switching column 262, a sheet name display column 263, an evaluation object editorial tool column 264, and an evaluation implementation column 265. Next, the evaluation object editorial section 26 editing an evaluation object supply chain by using evaluation units.

A sheet column 261 is a column pasting an evaluation unit and displays a result of a data link. As explained below, by selecting and setting up a process apparatus of an evaluation unit on the sheet column 261, input work of the evaluation data on the evaluation can be easily performed.

An evaluation axis switching column 262 is used for indicating an editorial sheet of the objected evaluating axis, and an evaluator can switch the indication by selecting an evaluation axis to edit and read.

A sheet name display column 263 indicates a name of the editorial sheet edited by the sheet column 261. A sheet object editorial tool column 264 indicates a name in the editorial sheet edited in the sheet column 261.

An evaluation object editorial tool column 264 can edit the evaluation method program 13 to generate and delete an evaluation unit. An evaluation implementation column 265, evaluates, calculates, saves a editorial sheet, and indicates the results.

As follows, are shown the steps to set up an evaluation unit and to edit an evaluation object supply chain.

First, an “add” button is selected in the evaluation object editorial tool column 264; an optional place of the sheet column 261 is selected; and an evaluation unit in the selected space is added. The sheet column 261 consists of boxes, and it is favorable to input an evaluation unit in each box, however, it is not limited herein. If there is an additional event of the evaluation unit, a property (see FIG. 8) setting up the added evaluation unit, is indicated.

After adding two or more evaluation units, “link line” button of the evaluation object editorial tool column 264 is selected; data link of the evaluation unit is implemented. That is, a chain classification is specified, and then, an apparatus classification, an apparatus name, an input item number or input item name of the input data setting up column 233 subjected for a data link are specified; a chain classification, an apparatus classification, an apparatus name, output item number or output item name of the output data setting up column 234 subjected to data link, are specified.

Designation of an input item name and an output item name, can be performed, for example, by specifying in an evaluation unit property picture (see FIG. 8) of an input or output terminal. As another method, an input number or an output number corresponding to the items of the evaluation unit is selected, as shown in FIG. 5 (B).

When redoing the editing, it is possible to delete the evaluation unit by “delete” button of the evaluation object editorial tool column 264, or delete the data link by “delete link line”. In these deletions, it is possible to collectively delete the deletion objects in the deletion range by designating the deletion range. When editing plural editorial objects correctively as a group, each of the button of “grouping”, “group registration”, “group paste” is selected.

By pushing a “calculation” button in the evaluation implementation column 265, a calculation mode is selected. In the calculation mode, implementation in the number of calculations and the fittest calculation is performed. Once the calculation mode is selected, the evaluation method program 13 and evaluation result data 14 in each evaluation unit, are read in the memory and sent to the CPU6. An evaluation section 25 calculates by following the evaluation method routine described in the evaluation method program 13, then, the calculation result is stored in a “result” column of the output setting up table 14c.

Furthermore, the calculation results of the evaluation section 25 are obtained from the evaluation setting up Table 14c, then, shown in a graphic format, by pushing “graph” button of the evaluation implementation column 265, a chain classification/an apparatus name and output item name are used as a key, and by this procedure, a flow of the output results in whole of the supply chain can be seen.

An example of the result indication by “graph” is shown in FIG. 11.

Graph 1100 is indicated on a different window from the picture in FIG. 10. On the window, a calculation sheet selection function 1101 is provided to select the data in each calculation sheet and to indicate the graph. By using the calculation sheet selection function 1101, each sheet and whole of the calculated sheet can be indicated.

In the same way, an evaluation axis selection function 1102 is provided in order to select data for each indication axis of the object calculation sheet and to indicate a graph. Also, an evaluation item selection function 1103 is provided in order to select data in each evaluation item and to indicate a graph.

A calculation sheet selection function 1101, an evaluation axis selection function 1102, and an evaluation item selection function 1103 determine id_sheet, an evaluation axis, and an evaluation item name of the output setting up Table 14c shown in Table 16, respectively, and extract the correspondent data. Then, the functions 1101, 1102, 1103 determine the order of the data to be displayed based on the coordinates data (x, y) of the unit setting up Table 14d shown in Table 17.

A picture display in FIG. 11 is provided with a scale change function 1105 to change the scale of the graph 1100. In a scale set-up, a user inputs the lower limit value (minimum) and the upper limit value (maximum), and clicks the graph renewal button. And then, a renewal event is generated to lead the graph 1100 renewed.

When a file output button 1106 is pushed, the output graph 1100 stores the extracted data in a general sheet format like table calculation software, and then, can output the data as a file.

When a “save” button of the evaluation implementation column 265 is pushed, the editorial contents of the evaluation object editorial section 26 are saved as a file. When a “clear” button is pushed, the editorial contents of the evaluation object editorial section 26 is cleared (deleted). When an “original fuel setting up” button is pushed, a data editorial picture is displayed for the evaluation data control section 24 to edit the basic fuel table 11b. When an “end” button is pushed, the evaluation object editorial section 26 is closed.

### BRIEF DESCRIPTION OF DRAWING

FIG. 1 is a construction drawing showing the hardware construction of the energy supply system evaluation device related to an implementation form of the present invention.

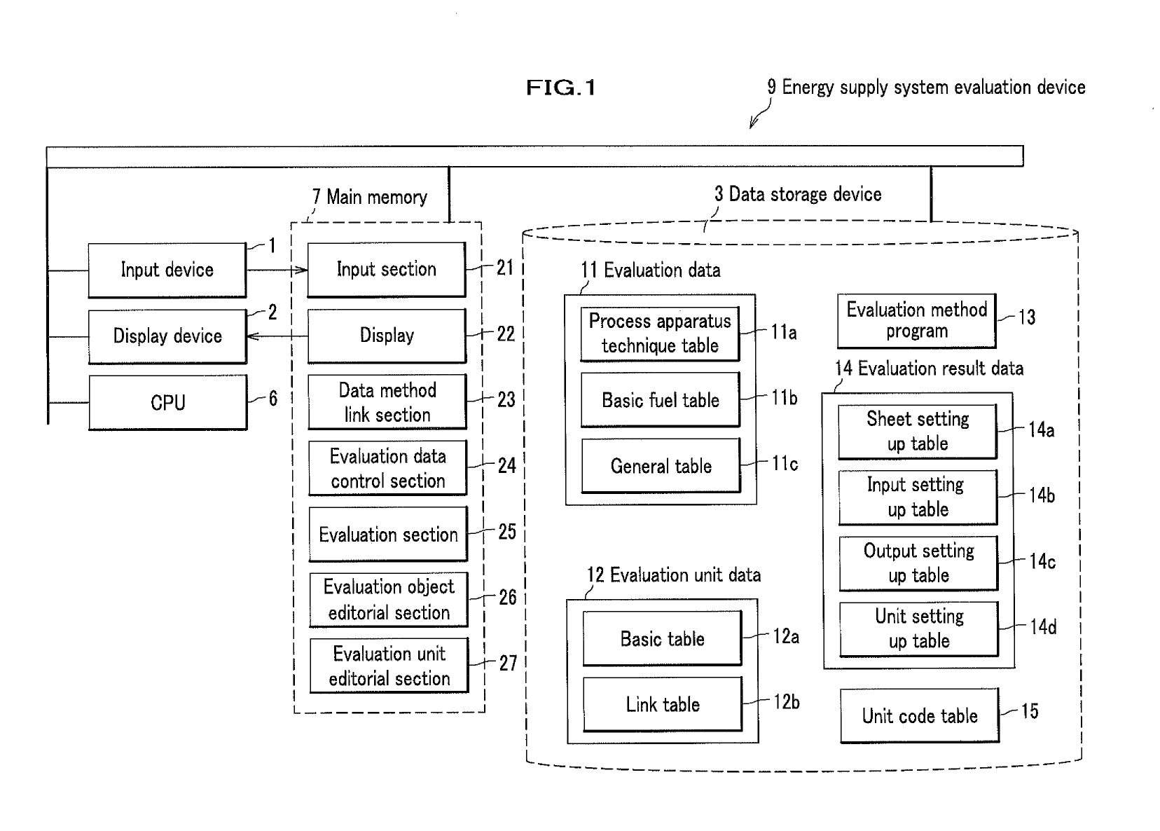

FIG. 2 is a construction drawing, wherein the energy supply system evaluation device related to an implementation form of the present invention is a decentralized system.

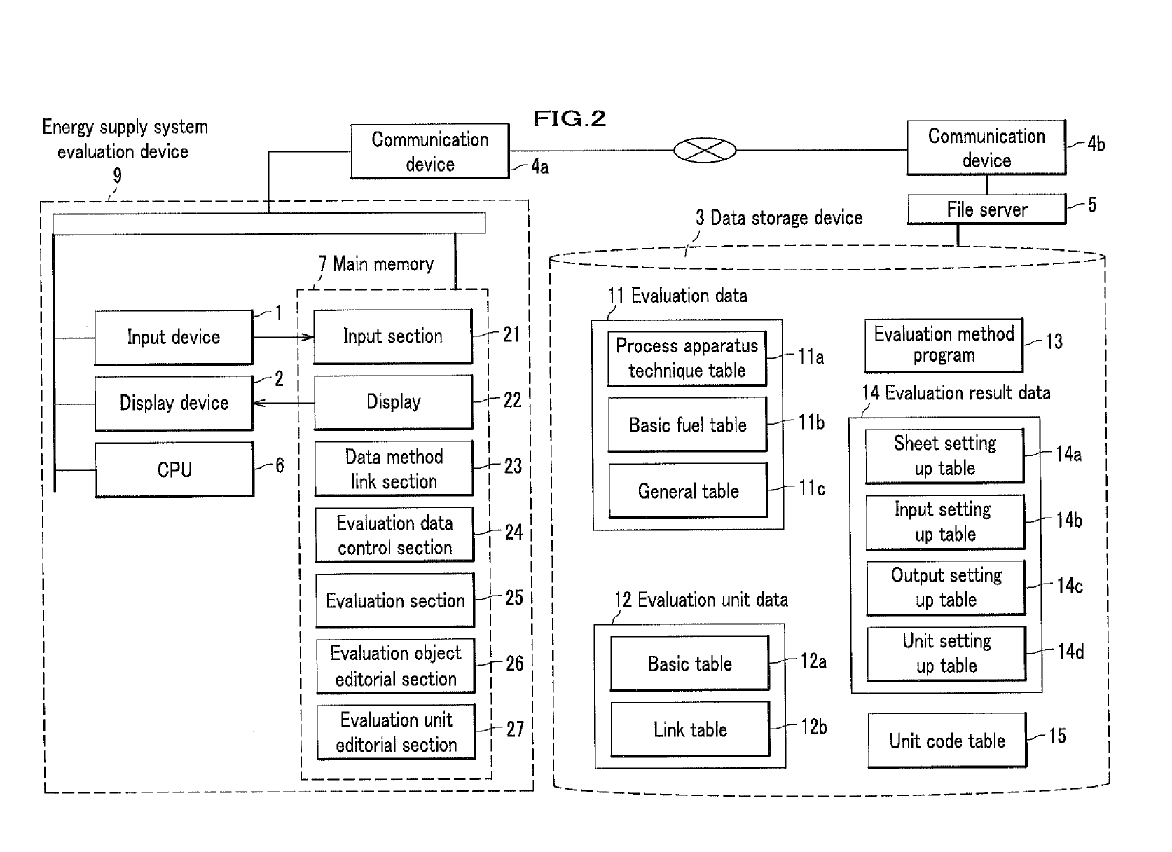

FIG. 3 is a construction drawing showing the function of the energy supply system evaluation device related to an implementation form of the present invention.

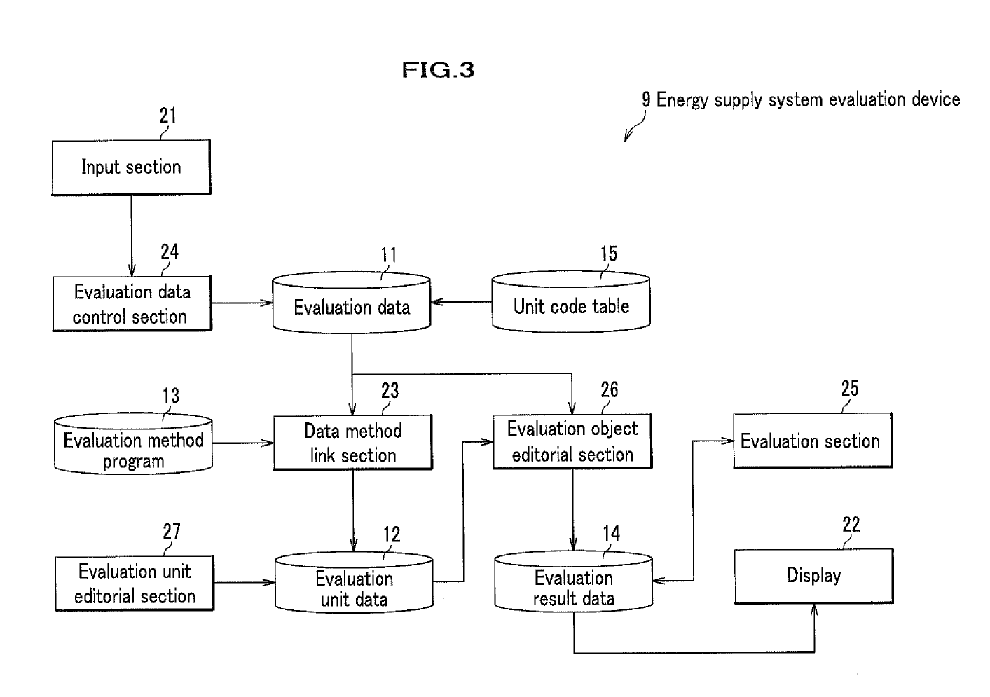

FIG. 4 is an explanatory drawing showing an editorial processing of the energy supply system evaluation device related to an implementation form of the present invention.

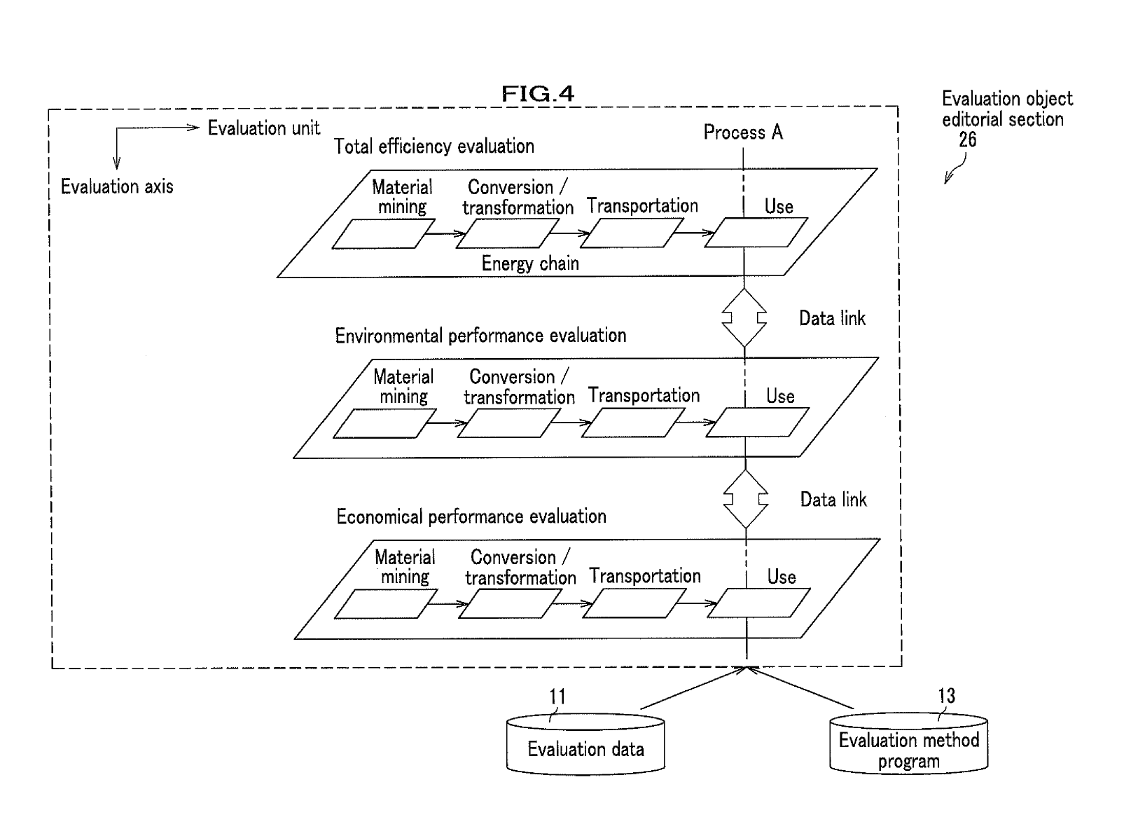

FIG. 5 is an outline drawing showing an evaluation unit of the evaluation unit data related to an implementation form of the present invention.

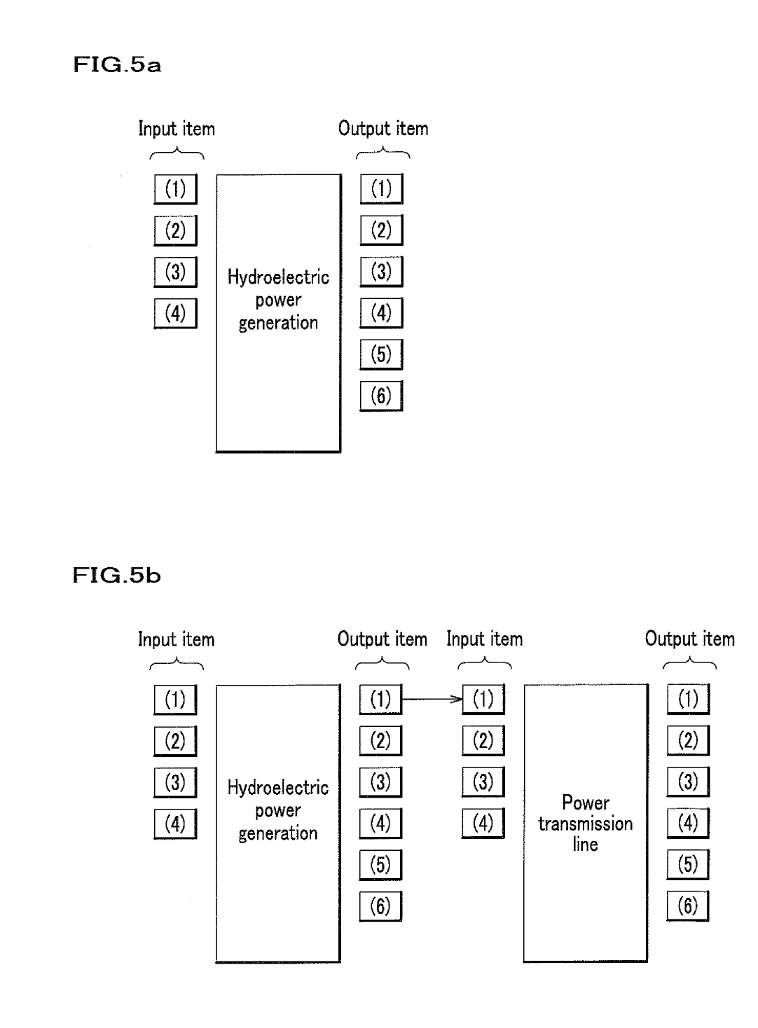

FIG. 6 is an explanatory drawing showing an example of the evaluation method program related to an implementation form of the present invention.

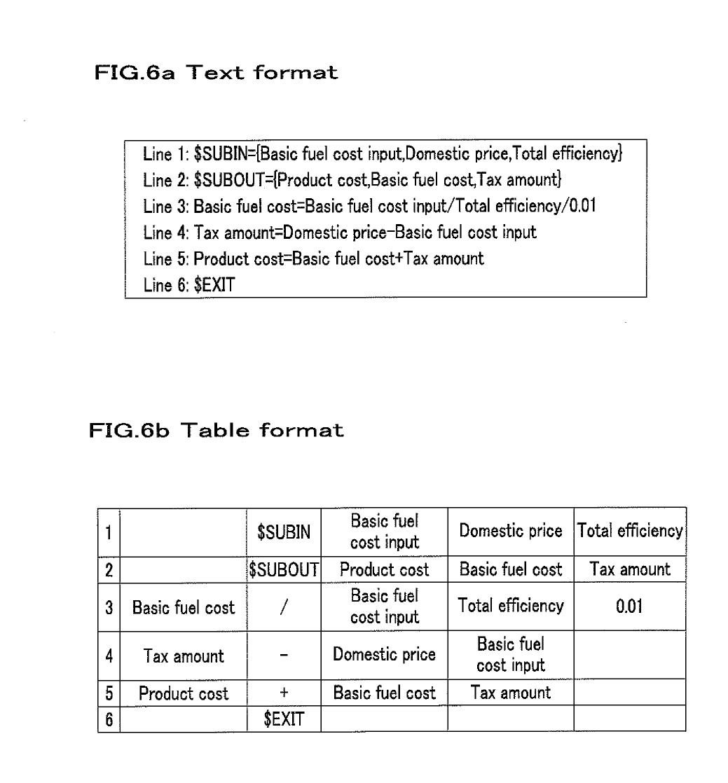

FIG. 7 is a picture drawing showing data editorial processing of the evaluation data control section related to an implementation form of the present invention.

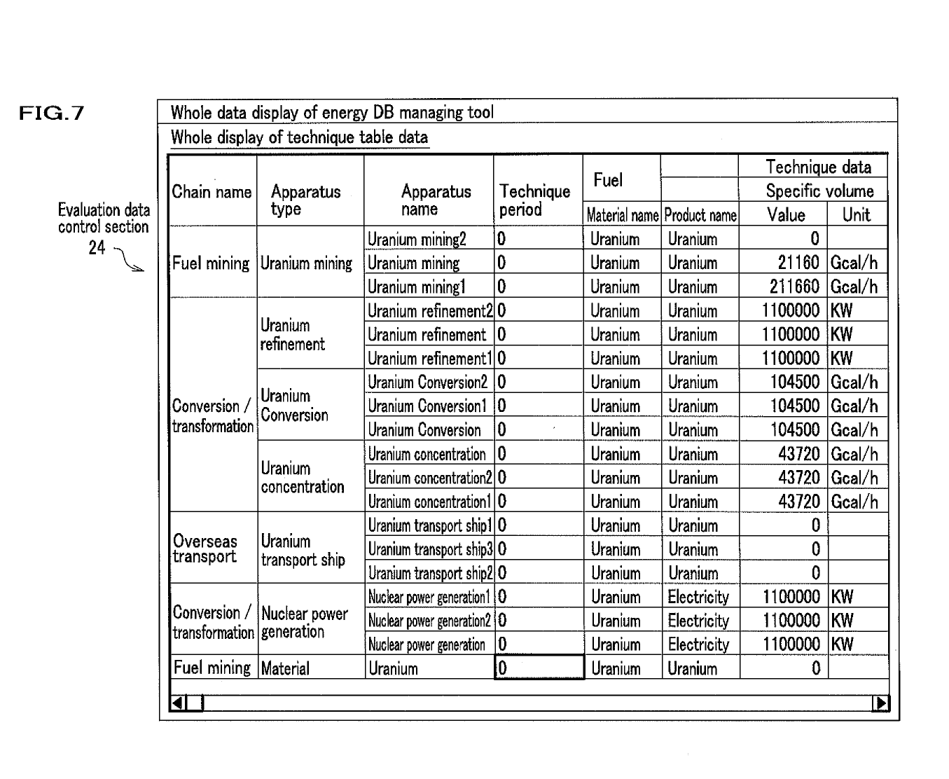

FIG. 8 is an explanatory drawing showing a picture display implemented by the evaluation unit editorial section related to an implementation form of the present invention.

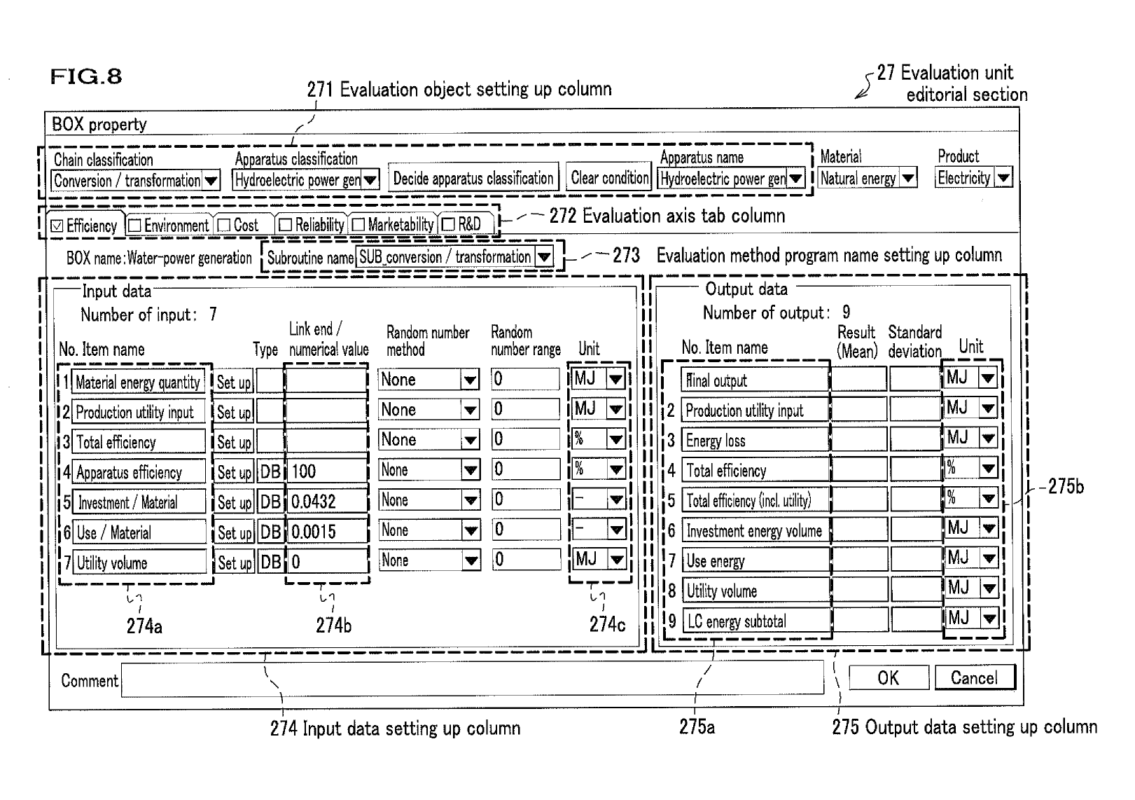

FIG. 9 is a picture drawing showing an example of the setting up picture of the data method link section related to an implementation form of the present invention.

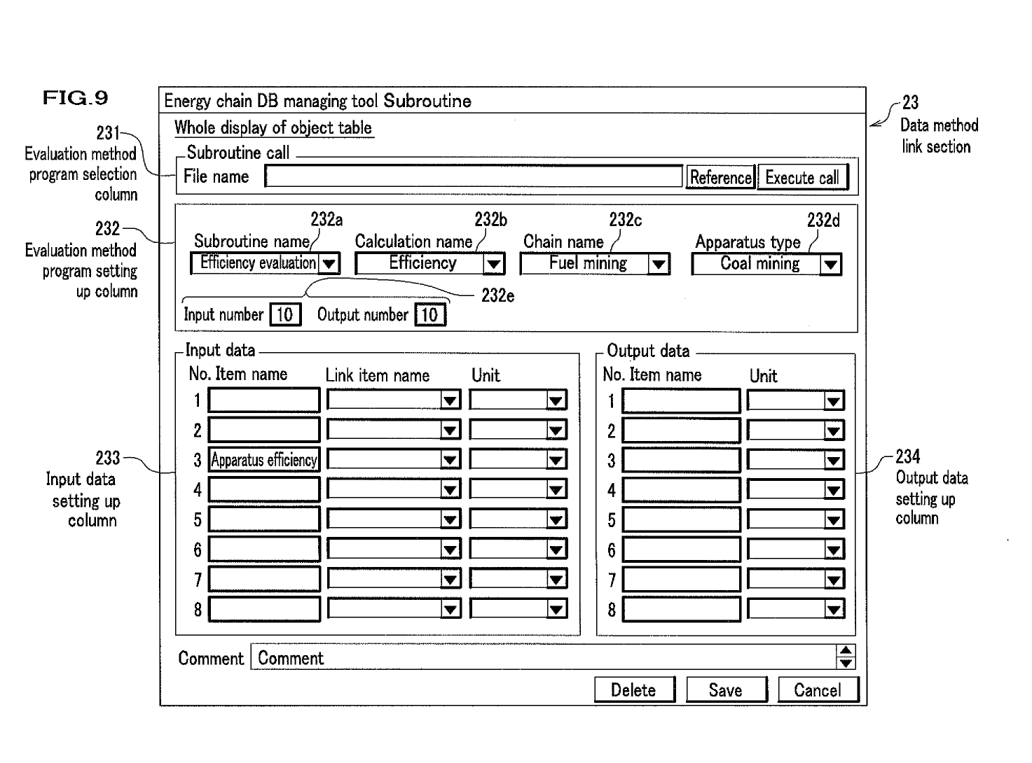

FIG. 10 is a picture drawing showing an example of the picture of the evaluation object editorial section related to an implementation form of the present invention.

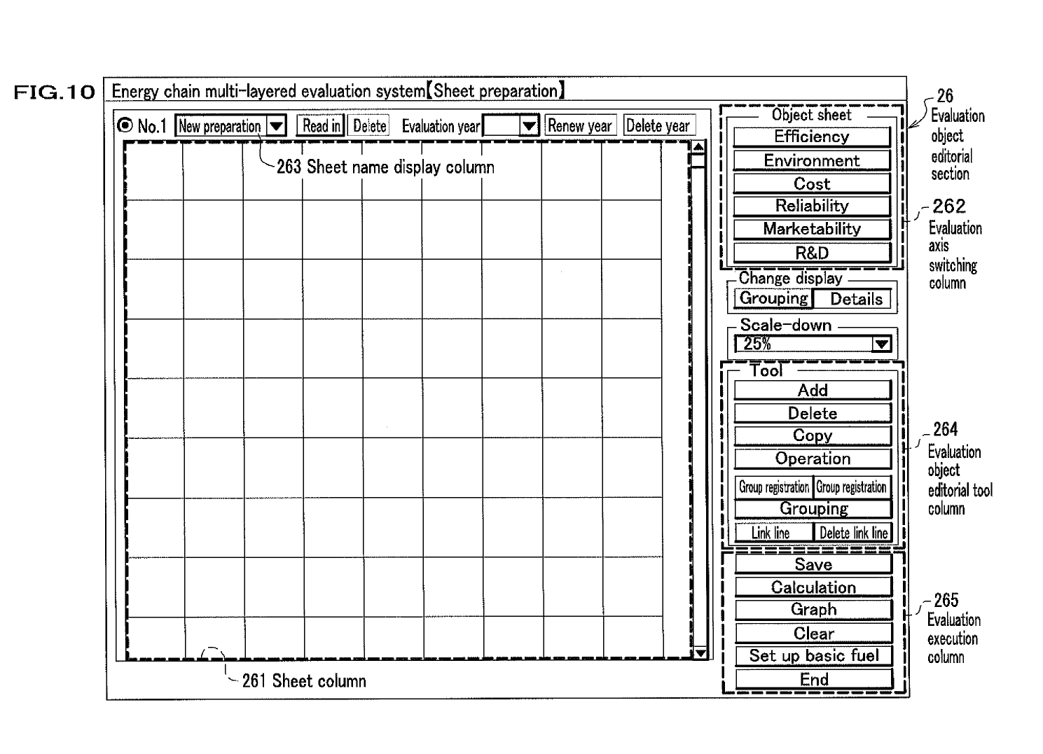

FIG. 11 is a picture drawing showing an example of the graphic picture showing the calculation result of the evaluation section related to an implementation form of the present invention.

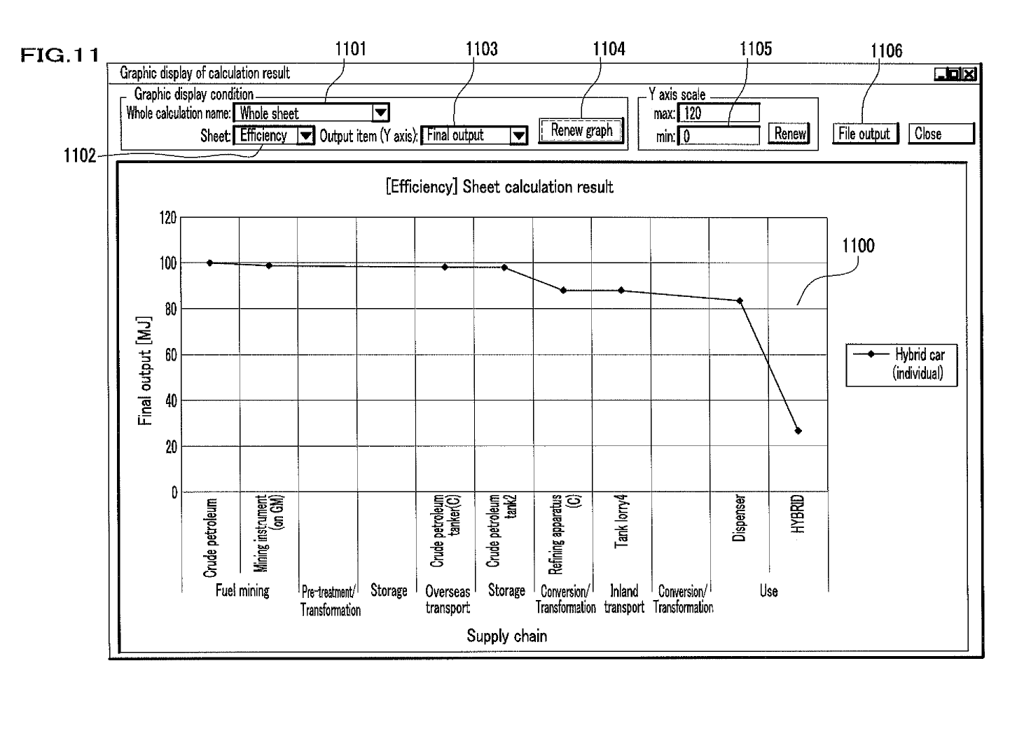

What is claimed is:

1. An energy supply system evaluation device for evaluating a lifecycle of energy conversion processes to be implemented in a pre-determined order by an energy supply system based on plural evaluation axes, comprising:
a memory section memorizing apparatus data of each apparatus which implements the energy conversion process, the evaluation axes to evaluate the energy supply system, and evaluation method programs to implement evaluation methods on the energy supply system,
an evaluation object editorial section receives data on the lifecycle as an evaluation object by receiving each evaluation unit consisting of either the energy conversion process or an apparatus unit which implements the energy conversion process, and a link relationship between a designated evaluation unit and other evaluation unit,
a data method link section which obtained an input item and an output item for the evaluation method program, both of which are associated with the evaluation units by looking up the apparatus data in the memory section by using each of the evaluation units belonging to the input lifecycle, selects the evaluation method program based on the evaluation axis, and links the input item and the output item of the evaluation data to the specified evaluation method program,
an evaluation section for evaluating each evaluation unit by implementing the linked evaluation method program by using the linked input item and output item, and
a display showing an evaluation result produced by the evaluation section in each evaluation unit.

2. An energy supply system evaluation device according to claim 1, wherein the memory section memorizes the evaluation method program including a declaration sentence of a variable indicating the input item and the output item.

3. An energy supply system evaluation device according to claim 1, wherein
the memory section stores a correspondence table comprised of a unit ID to identify a unit and a unit code both of which correspond to each other, and
the data method link section searches the apparatus data by using a value of the evaluation axis in each evaluation unit or a unit code corresponding to the value as a searching key.

4. An energy supply system evaluation device according to claim 1, wherein the data method link section selects one candidate from among plural evaluation method programs, and links the selected evaluation method program to the evaluation data, if there are plural evaluation method program candidates which evaluate the designated evaluation unit.

5. An energy supply system evaluation device according to claim 1, wherein the energy supply system evaluation device reads the output item of the evaluation result based on the first evaluation unit which exists before the lifecycle, and sets up the input item of the second evaluation unit which exists after the lifecycle, when the evaluation section evaluates a total evaluation for all of the inputted evaluation units belonging to the lifecycle.

6. An energy supply system evaluation method for evaluating a lifecycle of energy conversion processes to be implemented in a pre-determined order by an energy supply system based on plural evaluation axes, comprising the steps of;
a computer which accesses a memory section for memorizing apparatus data of each apparatus implementing the energy conversion process, the evaluation axes to evaluate the energy supply system, and evaluation method programs to implement evaluation methods on the energy supply system,
receives data on the lifecycle as an evaluation object by receiving each of the evaluation units consisting of either the energy conversion process or apparatus units which implement the energy conversion process, and link relationships between a designated evaluation unit and other evaluation unit,
obtains an input item and an output item for the evaluation method program, both of which are associated with the evaluation unit by looking up the apparatus data in the memory section by using each of the evaluation units belonging to the input lifecycle,
selects the evaluation method program based on the evaluation axis,
links the input item and the output item of the evaluation data to the specified evaluation method program, evaluates each evaluation unit by implementing the linked evaluation method program by using the linked input item and output item, and
displays an evaluation result produced by the evaluation section in each evaluation unit.

7. An energy supply system evaluation method program which implements the energy supply system evaluation method according to claim 6 on a computer.
